(19) United States
(12) Patent Application Publication
(10) Pub. No.: US 2022/0317494 A1
(43) Pub. Date: Oct. 6, 2022

(54) LOW TEMPERATURE POLY-SILICON DISPLAY PANELS, MANUFACTURING METHOD THEREOF, AND LIQUID CRYSTAL DISPLAY DEVICES

(71) Applicant: Xiamen Tianma Micro-Electronics Co., Ltd., Xiangan (CN)

(72) Inventors: Xiaoli LIU, Shanghai (CN); Yongjin TENG, Xiamen (CN); Limin LIN, Xiamen (CN); Yingzhang QIU, Xiamen (CN)

(73) Assignee: Xiamen Tianma Micro-Electronics Co., Ltd., Xiamen (CN)

(21) Appl. No.: 17/413,788

(22) PCT Filed: May 19, 2020
(86) PCT No.: PCT/CN2020/091096

§ 371 Date: Jun. 14, 2021

(30) Foreign Application Priority Data
Apr. 3, 2020 (CN) 202010259097.3

(51) Int. Cl. G02F 1/1333; G02F 1/1362

(52) U.S. Cl. CPC G02F 1/13338; G02F 1/136277; G02F 1/136222; G02F 1/136209; G02F 1/136295; G06F 3/04164

(57) ABSTRACT

Embodiments of the present disclosure provide a low temperature poly-silicon display panel, a manufacturing method thereof, and a liquid crystal device, which relate to the display technology and improve the light leakage of the metal. The low temperature poly-silicon display panel includes an array substrate and an alignment substrate that are opposite to each other, and liquid crystals filled between the array substrate and the alignment substrate. The array substrate includes a base substrate, and a low temperature poly-silicon active layer, a gate layer, and a source-drain layer are arranged on the base substrate. The low temperature poly-silicon display panel further includes a color filter layer disposed on the array substrate and located on a side of the source-drain layer facing away from the base substrate, and a light shielding layer configured to define an opening region of the low temperature poly-silicon display panel. At least part of the light shielding layer is provided on the array substrate, and the light shielding layer provided on the array substrate is located on the side of the source-drain layer facing away from the base substrate.

### CROSS-REFERENCE TO RELATED APPLICATIONS

The present application is a U.S. national stage application of International Patent Application No. PCT/CN2020/091096, filed May 19, 2020, which claims priority to Chinese Patent Application No. 202010259097.3, titled “LOW TEMPERATURE POLY-SILICON DISPLAY PANEL, MANUFACTURING METHOD THEREFOR, AND LIQUID CRYSTAL DISPLAY DEVICE” and filed on Apr. 3, 2020, the content of which is incorporated by reference in its entirety.

### TECHNICAL FIELD

The present disclosure relates to the field of display technology, in particular to a low temperature poly-silicon display panel and a manufacturing method of the low temperature poly-silicon display panel, and a liquid crystal display device.

### BACKGROUND

Low temperature poly-silicon (LTPS) display panels have the advantages of high resolution, fast response, high brightness, etc., and have been more widely applied. The LTPS liquid crystal display panel includes an array substrate and a color filter substrate that are opposite to each other, a thin film transistor layer is provided on the array substrate, and a color filter layer and black matrixes are provided on the color filter substrate. However, if a panel with this structure is applied to a curved screen, the relative position of the color filter substrate and the array substrate will be shifted after the color filter substrate and the array substrate are bent. Accordingly, the metal layer in the array substrate is exposed in the opening region defined by the black matrixes on the color filter substrate and thus light leakage of the metal occurs.

So far, limited by the process factors of the LTPS display panel, the color filter on array (COA) technology is difficult to improve the current problem. The possibility of exposing the metal layer to the opening is reduced merely by reducing the area of the opening region.

However, the pixel density of the LTPS display panel is relatively high, and the area of the opening region of a single subpixel is generally small. If the light leakage of the metal is reduced by reducing the area of the opening region, the display of the LTPS display panel will be significantly affected.

### SUMMARY

In view of this, embodiments of the present disclosure provide a low temperature poly-silicon display panel and a manufacturing method of the low temperature poly-silicon display panel, and a liquid crystal display device, which can effectively improve light leakage of the metal while ensuring that the low temperature poly-silicon display panel has a high display performance.

On the one hand, some embodiments of the present disclosure provide a low temperature poly-silicon display panel. In an embodiment, the low temperature poly-silicon display panel includes an array substrate and an alignment substrate opposite the array substrate, liquid crystals filled between the array substrate and the alignment substrate, a color filter layer provided on the array substrate and located on a side of the source-drain layer facing away from a base substrate, and a light shielding layer configured to define an opening region of the low temperature poly-silicon display panel. In an embodiment, the array substrate includes the base substrate, and a low temperature poly-silicon active layer, a gate layer, and a source-drain layer are sequentially arranged on the base substrate along a light emitting direction. In an embodiment, at least part of the light shielding layer is provided on the array substrate, and the light shielding layer provided on the array substrate is located on the side of the source-drain layer facing away from the base substrate.

On the other hand, some embodiments of the present disclosure provide a manufacturing method of a low temperature poly-silicon display panel for manufacturing the above low temperature poly-silicon display panel. In an embodiment, the manufacturing method includes forming the array substrate, forming the alignment substrate, and oppositely arranging the array substrate and the alignment substrate to form a cell and injecting the liquid crystals between the array substrate and the alignment substrate. In an embodiment, the forming the array substrate includes sequentially forming the low temperature poly-silicon active layer, the gate layer, and the source-drain layer on the base substrate, and forming the color filter layer and the at least part of the light shielding layer on the side of the source-drain layer facing away from the base substrate. In an embodiment, when forming the low temperature poly-silicon active layer, laser annealing is performed on the low temperature poly-silicon active layer at a temperature ranging from 500° C. to 600° C., and when forming the source-drain layer, high-temperature tempering is performed on the source-drain layer at a temperature ranging from 300° C. to 400° C. The light shielding layer is configured to define the opening region of the low temperature poly-silicon display panel.

In another aspect, some embodiments of the present disclosure provide a liquid crystal display device including the above low temperature poly-silicon display panel.

One of the above technical solutions has the following beneficial effects.

In the technical solutions provided by embodiments of the present disclosure, the color filter layer and the at least part of the light shielding layer are disposed on the array substrate. That is, the metal layers on the array substrate, such as the gate layer and the source-drain layer, are located at a same side as the at least part of the light shielding layer. In an embodiment, when the low temperature poly-silicon display panel is bent, the relative positional relationship between the metal layers and this part of the light shielding layer will not be affected by the alignment factors between the array substrate and the alignment substrate. In an embodiment, the metal layers and the light shielding layer that are located in the same region of the array substrate have similar deformation degrees under the same bending force, such that the metal layers in this region are still shielded by the light shielding layer, which reduces the risk of exposure to the opening region, thereby effectively improving the phenomenon of light leakage of the metal. Moreover, compared with the method in the prior art in which the coverage area of the light shielding layer is increased to improve light leakage of the metal, the technical solutions provided by the embodiments of the present disclosure are unnecessary to adjust the coverage area of the light shielding layer, so that the low temperature poly-silicon display panel maintains a higher aperture ratio to have a better display performance.

Moreover, in the manufacturing process of the low temperature poly-silicon display panel, when forming the low temperature poly-silicon active layer, the laser annealing is perform on the low temperature poly-silicon active layer at the temperature ranging from 500° C. to 600° C., and when forming the source-drain layer, the high-temperature tempering is performed on the source-drain layer at the temperature ranging from 300° C. to 400° C. Since the current tolerance temperature of the materials for forming the light shielding layer and the color filter layer is lower than 250° C., in the embodiments of the present disclosure, the color filter layer and the at least part of the light shielding layer are disposed on the side of the source- drain layer facing away from the base substrate, which can perform the high-temperature treatment process required for the low temperature poly-silicon display panels before forming the color filter layer and the light shielding layer. In an embodiment, after the color filter layer and the light shielding layer are formed, it is unnecessary to perform the high-temperature processing, thereby preventing the color filter layer and the light shielding layer from being affected by the high-temperature process, improving the reliability of the arrangement of the color filter layer and the light shielding layer, and further improving the feasibility of integrating the color filter layer and the light shielding layer on the array substrate.

In addition, it should be noted that when only a part of the light shielding layer is provided on the array substrate, and this part of the light shielding layer is also used to define the opening region. Accordingly, in an embodiment, when the low temperature poly-silicon display panel is bent, the alignment stability between this part of the light shielding layer and the metal layers is increased such that the metal layers are still covered by the part of the light shielding layer, which can still reduce the risk of the metal layers being exposed to the opening region to a certain extent and improve the phenomenon of light leakage of the metal.

### BRIEF DESCRIPTION OF DRAWINGS

For the sake of clearly illustrating the technical solutions in the embodiments of the present disclosure, the accompanying drawings used in the embodiments are briefly described below. Obviously, the drawings described below are merely some embodiments of the present disclosure. Those skilled in the art can obtain other drawings without creative efforts.

FIG. 1 is a schematic structural diagram of a display panel according to an embodiment of the present disclosure;

FIG. 2 is a cross-sectional view of FIG. 1 along A1-A2 according to an embodiment of the present disclosure;

FIG. 3 is a schematic structural diagram of a planarization layer according to an embodiment of the present disclosure;

FIG. 4 is a schematic diagram of a position of a light shielding layer according to an embodiment of the present disclosure;

FIG. 5 is a schematic structural diagram of a light shielding layer according to an embodiment of the present disclosure;

FIG. 6 is another schematic structural diagram of a light shielding layer according to an embodiment of the present disclosure;

FIG. 7 is another schematic structural diagram of a light shielding layer according to an embodiment of the present disclosure;

FIG. 8 is another schematic diagram of a position of a light shielding layer according to an embodiment of the present disclosure;

FIG. 9 is another schematic diagram of a position of a light shielding layer according to an embodiment of the present disclosure;

FIG. 10 is another schematic diagram of a position of a light shielding layer according to an embodiment of the present disclosure;

FIG. 11 is another schematic diagram of a position of a light shielding layer according to an embodiment of the present disclosure;

FIG. 12 is another schematic diagram of a position of a light shielding layer according to an embodiment of the present disclosure;

FIG. 13 is another schematic diagram of a position of a light shielding layer according to an embodiment of the present disclosure;

FIG. 14 is another schematic diagram of a position of a light shielding layer according to an embodiment of the present disclosure;

FIG. 15 is another schematic diagram of a position of a light shielding layer according to an embodiment of the present disclosure;

FIG. 16 is another schematic diagram of a position of a light shielding layer according to an embodiment of the present disclosure;

FIG. 17 is a cross-sectional view of FIG. 1 along B1-B2 according to an embodiment of the present disclosure;

FIG. 18 is another cross-sectional view of FIG. 1 along B1-B2 according to an embodiment of the present disclosure;

FIG. 19 is a schematic diagram of a position of a connection layer according to an embodiment of the present disclosure;

FIG. 20 is a flowchart of a manufacturing method according to an embodiment of the present disclosure;

FIG. 21 is another flowchart of a manufacturing method according to an embodiment of the present disclosure; and

FIG. 22 is a schematic structural diagram of a liquid crystal display device according to an embodiment of the present disclosure.

### DESCRIPTION OF EMBODIMENTS

For the sake of better comprehension of the technical solutions of the present disclosure, the embodiments of the present disclosure are described in details with reference to the drawings.

It should be noted that the described embodiments are merely part of the embodiments of the present disclosure rather than all of the embodiments. Other embodiments obtained by those skilled in the art without creative efforts are within the scope of the present disclosure.

The terms used in the embodiments of the present disclosure are merely for the purpose of describing specific embodiments and not intended to limit the present disclosure thereto. Unless otherwise noted in the context, the singular form expressions “a”, “an”, “the” and “said” used in the embodiments and appended claims of the present disclosure are also intended to represent a plural form.

It should be understood that the term “and/or” as used herein is merely an association describing the associated object, indicating that there may be three relationships. For example, A and/or B may indicate three cases: A alone; A and B; B alone. In addition, a character “/” herein generally indicates that the contextual objects are in an “or” relationship.

It should be understood that although the terms first, second, etc. can be used to describe the insulating layers and the light shielding portions in the embodiments of the present disclosure, these insulating layers and the light shielding portions should not be limited to these terms. These terms are merely used to distinguish the insulating layers and the light shielding portions from each other. For example, without departing from the scope of the embodiments of the present disclosure, the first insulating layer can also be referred to as the second insulating layer, and similarly, the second insulating layer can also be referred to as the first insulating layer.

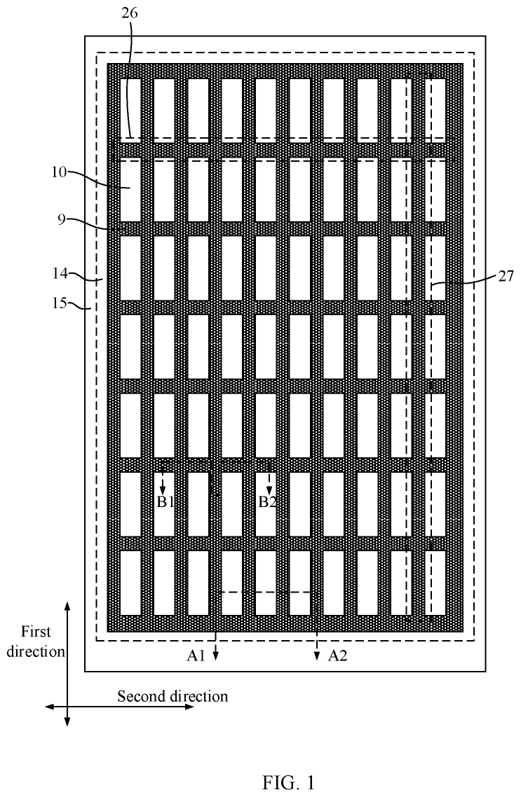

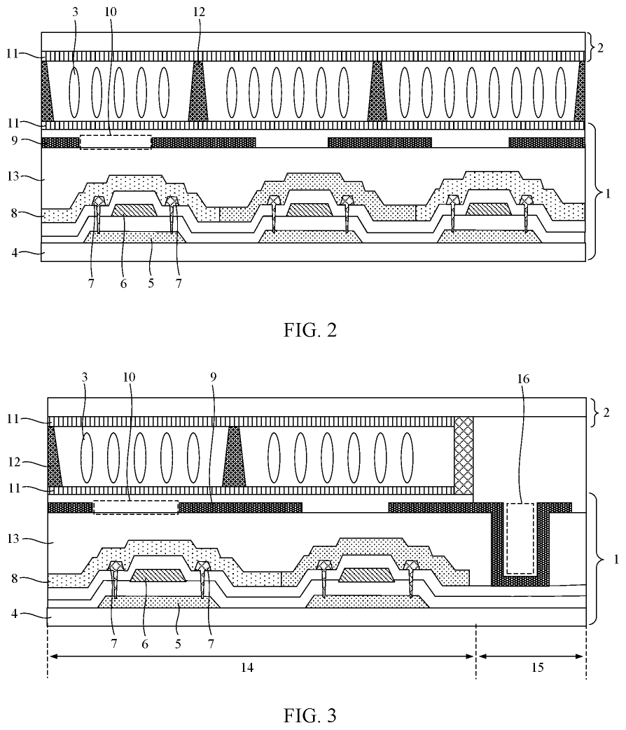

An embodiment of the present disclosure provides a low temperature poly-silicon display panel, as shown in FIG. 1 and FIG. 2. FIG. 1 is a schematic structural diagram of a display panel according to an embodiment of the present disclosure, and FIG. 2 is a cross-sectional view of FIG. 1 along A1-A2. The low temperature poly-silicon display panel includes an array substrate 1 and an alignment substrate 2 opposite the array substrate 1, and liquid crystals 3 filled between the array substrate 1 and the alignment substrate 2. The array substrate 1 includes a base substrate 4, and a low temperature poly-silicon active layer 5, a gate layer 6 and a source-drain layer 7 are sequentially arranged on the base substrate 4 along a light emitting direction of the low temperature poly-silicon display panel. It should be noted that the light emitting direction of the low temperature poly-silicon display panel refers to the direction of light emitted from the low-temperature poly-silicon display panel.

In addition, the low temperature poly-silicon display panel further includes a color filter layer 8 and a light shielding layer 9. The color filter layer 8 is provided on the array substrate 1 and located on a side of the source-drain layer 7 facing away from the base substrate 4. The light shielding layer 9 is used to define an opening region 10 of the low temperature poly-silicon display panel, that is, a light-emitting region of the low temperature poly-silicon display panel. At least part of the light shielding layer 9 is provided on the array substrate 1, and the light shielding layer 9 on the array substrate 1 is located on the side of the source-drain layer 7 facing away from the base substrate 4.

It can be understood that each of the array substrate 1 and the alignment substrate 2 is provided with an alignment layer 11 to drive the liquid crystals 3 to flip normally. In addition, spacers 12 are provided between the array substrate 1 and the alignment substrate 2 to stably support the gap. The spacers 12 may be provided on the array substrate 1 or on the alignment substrate 2, which is not limited in the embodiment of the present disclosure.

In the low temperature poly-silicon display panel according to the embodiment of the present disclosure, the color filter layer 8 and at least part of the light shielding layer 9 are disposed on the array substrate 1. That is, the metal layers on the array substrate 1, such as the gate layer 6 and the source-drain layer 7, are located at a same side as the at least part of the light shielding layer 9. When the low temperature poly-silicon display panel is bent, the relative positional relationship between the metal layers and this part of the light shielding layer 9 will not be affected by the alignment factor between the array substrate 1 and the alignment substrate 2. The deformation degrees of the metal layers and the light shielding layer 9 that are located in the same region of the array substrate 1 under the same bending force are similar to each other, such that the metal layers in this region is still shielded by the light shielding layer 9, thereby reducing the risk of being exposed to the opening region 10. Therefore, the phenomenon of light leakage of the metal can be effectively improved. Moreover, compared with the method in the prior art in which the coverage area of the light shielding layer is increased to improve the light leakage of the metal, the technical solution according to the embodiment of the present disclosure is not required to adjust the coverage area of the light shielding layer 9, thereby maintaining a higher aperture ratio of the low temperature poly-silicon display panel to achieve better display performance.

Moreover, in the process of the low temperature poly-silicon display panel, when forming the low temperature poly-silicon active layer 5, it is required to perform laser annealing on the low temperature poly-silicon active layer 5 at a temperature ranging from 500° C. to 600° C., and when forming the source-drain layer 7, it is required to perform high temperature tempering on the source-drain layer 7 at a temperature ranging from 300° C. to 400° C. Since the current tolerance temperature of the materials for forming the light shielding layer 9 and the color filter layer 8 is lower than 250° C., in some embodiments of the present disclosure, the color filter layer 8 and at least part of the light shielding layer 9 are arranged on the side of the source-drain layer 7 facing away from the base substrate 4, which can perform the high-temperature treatment process required for the low temperature poly-silicon display panels before forming the color filter layer 8 and the light shielding layer 9. After the color filter layer 8 and the light shielding layer 9 are formed, the high-temperature processing is not required, thereby preventing the color filter layer 8 and the light shielding layer 9 from being affected by the high-temperature process, improving the reliability of the arrangement of the color filter layer 8 and the light shielding layer 9, and further improving the feasibility of integrating the color filter layer 8 and the light shielding layer 9 on the array substrate 1.

In addition, it should be noted that when only a part of the light shielding layer 9 is provided on the array substrate 1, this part of the light shielding layer 9 is also used to define the opening region 10. Accordingly, when the low temperature poly-silicon display panel is bent, the alignment stability between this part of the light shielding layer 9 and the metal layers is increased, so that the metal layers are still covered by this part of the light shielding layer 9, which can still reduce the risk of the metal layers being exposed to the opening region 10 to a certain extent, and improve the phenomenon of light leakage of the metal.

Optionally, referring to FIG. 2 again, in order to realize planarization, the array substrate 1 further includes a planarization layer 13 located on a side of the color filter layer 8 facing away from the base substrate 4, and at least part of the light shielding layer 9 is located on a side of the planarization layer 13 facing away from the base substrate 4.

Optionally, in conjunction with FIG. 1 and as shown in FIG. 3, FIG. 3 is a schematic structural diagram of a planarization layer according to an embodiment of the present disclosure. The array substrate 1 has a display region 14 and a non-display region 15 surrounding the display region 14. The planarization layer 13 extends from the display region 14 to the non-display region 15, and the planarization layer 13 is provided with at least one groove 16 located in the non-display region 15.

An upper surface of the planarization layer 13 away from the base substrate 4 is a relatively flat surface in order to effectively achieve planarization. When the light shielding layer 9 is arranged on the side of the planarization layer 13 facing away from the base substrate 4, for example, the light shielding layer 9 is located on the upper surface of the planarization layer 13. When the light shielding layer 9 is formed, the entire upper surface of the planarization layer 13 is coated with a light shielding material, such as a black resin material, to form an entire layer of light shielding layer having a relative flat surface. It is difficult to align the mask with the light shielding layer in the subsequent exposure, and it is difficult to etch the light shielding layer to form the opening region 10. However, in the embodiments of the present disclosure, there is a height difference between a position of the at least one groove 16 and the surrounding position by providing the at least one groove 16 on a part of the planarization layer 13 located in the non-display region 15. In the subsequence process of coating with the light shielding material to form the light shielding layer, the light shielding layer will be recessed downwards at the at least one groove 16, such that the light shielding layer will form a grayscale difference between the position of the at least one groove 16 and the surrounding position. When the mask is aligned, the formed grayscale difference is an alignment mark, which achieves accurate alignment and improves the accuracy of etching, thereby improving the accuracy of the position of the opening region 10.

Moreover, compared with other layers on the array substrate 1, the planarization layer 13 has a larger thickness. Therefore, the at least one groove 16 is provided on the planarization layer 13. The height difference between the position of the at least one groove 16 and the surrounding position is relatively large. After subsequently coating with the light shielding material to form the light shielding layer, the greyscale difference between the position of the at least one groove 16 and the surrounding position is more significant, and thus can be better recognized.

In addition, refer to FIG. 3 again, the planarization layer 13 is hollow at the at least one groove 16, that is, the at least one groove 16 penetrates the planarization layer 13, in order to further increase the height difference and improve the recognition accuracy.

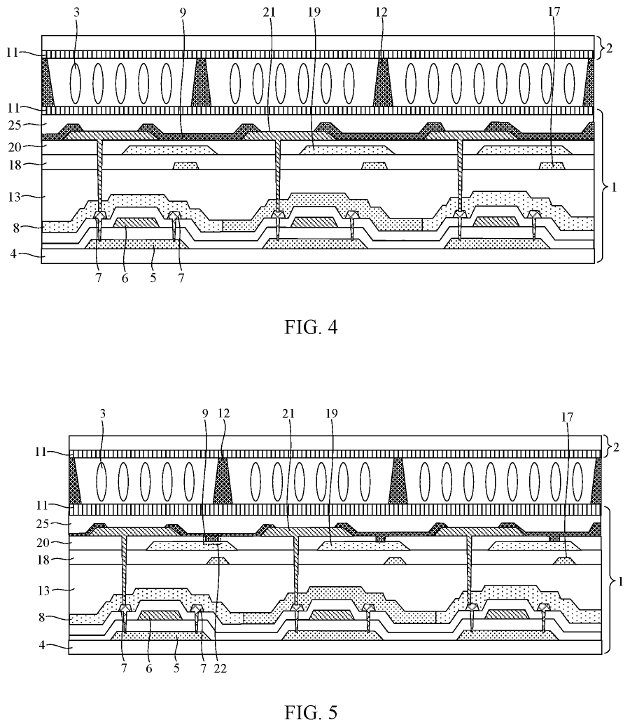

FIG. 4 is a schematic diagram of a position of the light shielding layer according to an embodiment of the present disclosure. The array substrate 1 further includes touch signal lines 17 provided on the side of the planarization layer 13 facing away from the base substrate 4, a first insulating layer 18 provided on a side of each of the touch signal lines 17 facing away from the base substrate 4, a common electrode 19 provided on a side of the first insulating layer 18 facing away from the base substrate 4 and reused as touch electrodes and electrically connected to the touch signal lines (not shown in the figure), a second insulating layer 20 provided on a side of the common electrode 19 facing away from the base substrate 4, and pixel electrodes 21 located on a side of the second insulating layer 20 facing away from the base substrate 4. The pixel electrodes 21 are electrically connected to the source-drain layer 7. The common electrode 19 and the pixel electrodes 21 may be made of a transparent conductive material, such as indium tin oxide. Specifically, when the low temperature poly-silicon display panel is in a display mode, the common electrode 19 receives a common electrode signal. The source-drain layer 7 provides a driving signal to the pixel electrodes 21, such that an electric field is formed between the common electrode 19 and each of the pixel electrodes 21 to drive the liquid crystals 3 to flip, thereby realizing normal display. When the low temperature poly-silicon is in a touch mode, the common electrode 19 is reused as the touch electrode. When the finger touches the display screen, a coupling capacitance of the common electrode 19 at the position of the finger will change, and the driving chip will then determine the touch position of the finger based on a detection signal transmitted by the touch signal lines 17.

In view of the above, at least part of the light shielding layer 9 is located on a side of each of the pixel electrodes 21 facing away from the base substrate 4. As a result, on the premise that the light leakage of the metal is effectively improved and the low temperature poly-silicon display panel maintains a high aperture ratio, when forming the light shielding layer 9, the process of forming the light shielding layer 9 is required merely after the pixel electrodes 21 are formed, and the original process of the array substrate 1 will not be greatly affected.

FIG. 5 is a schematic structural diagram of a light shielding layer according to an embodiment of the present disclosure. The second insulating layer 20 is provided with a first via 22 located in a non-opening region of the low temperature poly-silicon display panel. A part of the light shielding layer 9 is deposited in the first via 22 of the second insulating layer 20, and the non-opening region refers to a region except for the opening region, which does not emit light. Each of the pixel electrodes 21 is an independent block electrode. Hence, when the light shielding layer 9 is arranged on the side of the pixel electrode 21 facing away from the base substrate 4, a part of the light shielding layer 9 will extend from the pixel electrode 21 to the second insulating layer 20 and is in direct contact with the second insulating layer 20. The first via 22 is formed on the second insulating layer 20 such that when coating with the light shielding material to form the light shielding layer 9, a part of the light shielding material will sink into the first via 22, which reduces a layer thickness of the light shielding layer 9 formed by the light shielding material, and avoids that the upper surface of the array substrate is greatly undulated due to the excessive large thickness of the light shielding layer 9, thereby facilitating the subsequent coating and alignment of the alignment layer 11.

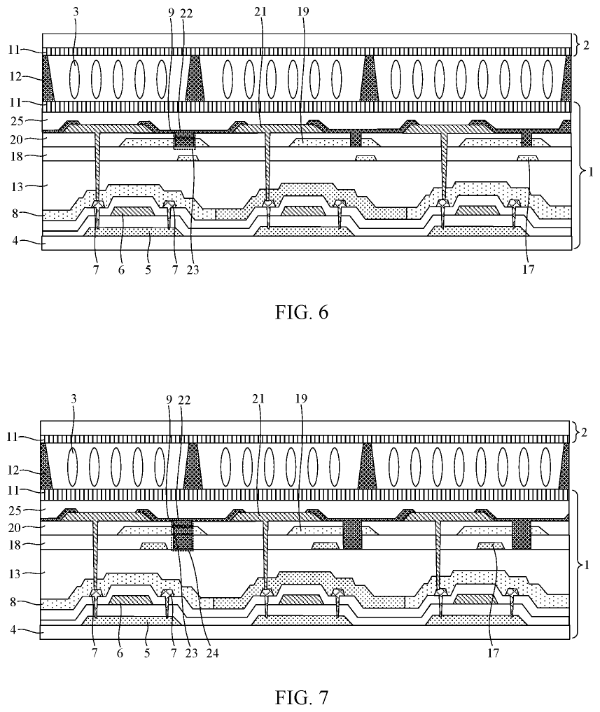

FIG. 6 is another schematic structural diagram of a light shielding layer according to an embodiment of the present disclosure. The second insulating layer 20 is provided with the first via 22, and the common electrode 19 is provided with a second via 23. The first via 22 and the second via 23 are located in the non-opening region of the low temperature poly-silicon display panel, and a part of the light shielding layer 9 is deposited in the first via 22 and the second via 23. The second via 23 is further provided on the common electrode 19 such that the light shielding material may further sink into the second via 23 through the first via 22, thereby further reducing the thickness of the light shielding layer 9 and further increasing the flatness of the upper surface of the entire layer of the array substrate 1.

FIG. 7 is another schematic structural diagram of a light shielding layer according to an embodiment of the present disclosure. The second insulating layer 20 is provided with the first via 22, the common electrode 19 is provided with the second via 23, and the first insulating layer 18 is provided with a third via 24. The first via 22, the second via 23 and the third via 24 are located in the non-opening region of the low temperature poly-silicon display panel, and a part of the light shielding layer 9 is deposited in the first via 22, the second via 23, and the third via 24. The third via 24 is further provided on the first insulating layer 18 such that the light shielding material may further sink into the third via 24 through the first via 22 and the second via 23, thereby reducing the thickness of the light shielding layer to a greater extent and further improving the flatness of the upper surface of the entire layer of the array substrate 1 to a greater extent.

In addition, the vias are provided in the layers on the side of the planarization layer 13 facing away from the base substrate 4 such that the small molecules in the color filter layer 8 and other organic layers, which are not completely volatilized, are volatilized through the vias in the subsequent manufacturing process, thereby avoiding that small molecules remains in the panel and thus affect the working stability of the panel.

Further, referring to FIG. 4 again, a liquid adhesive 25 is formed on the side of the light shielding layer 9 facing away from the base substrate 4. The liquid adhesive is formed on an upper side of the light shielding layer 9 such that the upper surface of the entire layer of the array substrate 1 is planarized by the liquid adhesive 25, which is beneficial to the subsequent coating and alignment of the alignment layer 11. Moreover, refer to FIG. 5 to FIG. 7, when vias are formed on the layers under the light shielding layer 9, such as the first via 22, the second via 23 and the third via 24, the layer thickness of the light shielding layer 9 is small, and the undulation degree of the upper surface of the overall layer of the array substrate 1 is also small. When coating with the liquid adhesive 25, only a thinner liquid adhesive 25 is used to achieve flatness, thereby reducing the distance between the pixel electrodes 21 and the liquid crystals 3 and improving the driving effect of the pixel electrodes 21 on the liquid crystals 3. In addition, the liquid adhesive 25 also is capable of isolating the light shielding layer 9 to prevent the liquid crystals 3 from being contaminated by additives in the organic material of the light shielding layer 9.

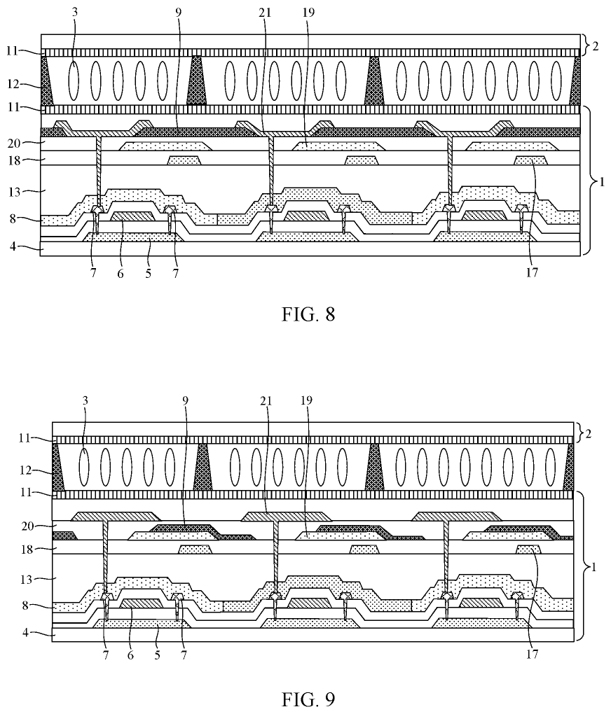

FIG. 8 is another schematic diagram of a position of a light shielding layer according to an embodiment of the present disclosure. The array substrate 1 further includes the touch signal lines 17 arranged on the side of the planarization layer 13 facing away from the base substrate 4, the first insulating layer 18 provided on the side of each of the touch signal lines 17 facing away from the base substrate 4, the common electrode 19 provided on the side of the first insulating layer 18 facing away from the base substrate 4 and reused as touch electrodes and electrically connected to the touch signal lines 17 (not shown in the figure), the second insulating layer 20 provided on the side of the common electrode 19 facing away from the base substrate 4, and the pixel electrodes 21 located on the side of the second insulating layer 20 facing away from the base substrate 4. The pixel electrodes 21 are electrically connected to the source-drain layer 7.

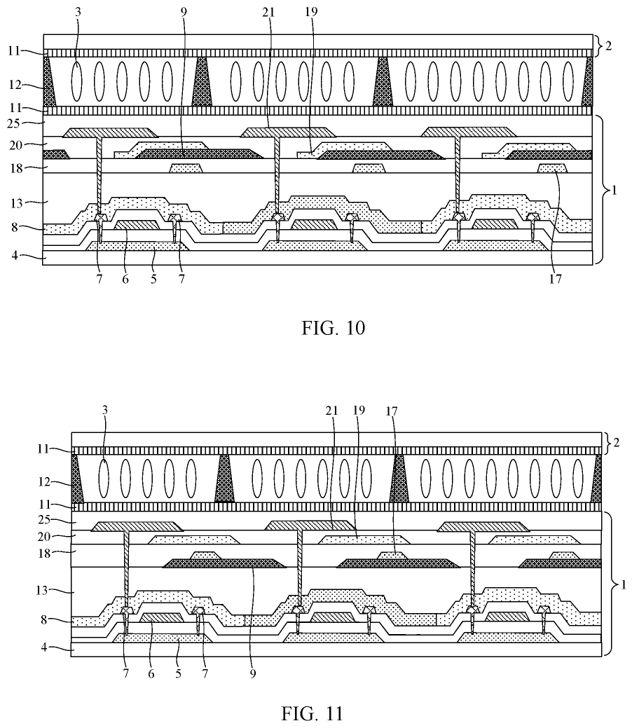

In view of the above, refer to FIG. 8 again, at least part of the light shielding layer 9 is located between the second insulating layer 20 and the pixel electrodes 21; or, as shown in FIG. 9, FIG. 9 is another schematic diagram of a position of a light shielding layer according to an embodiment of the present disclosure, and at least part of the light shielding layer 9 is located between the common electrode 19 and the second insulating layer 20; or, as shown in FIG. 10, FIG. 10 is another schematic diagram of a position of a light shielding layer according to an embodiment of the present disclosure, and at least part of the light shielding layer 9 is located between the common electrode 19 and the first insulating layer 18.

With the above configuration, under the premise of effectively improving light leakage of the metal and keeping the low temperature poly-silicon display panel with a high aperture ratio, on the one hand, the light shielding layer 9 is located on the side of each of the touch signal lines 17 facing away from the base substrate 4, and besides shielding the source-drain layer 7, the gate layer 6, and other metal layers, the light shielding layer 9 also shields the touch signal lines 17, thereby greatly reducing the risk of the metal being visitable. On the other hand, the light shielding layer 9 may also increase the distance between the pixel electrodes 21 and other metal layers, such as the touch signal lines 17, the source-drain layer 7, and the gate layer 6, and also increase the distance between the common electrode 19 and these other metal layers, thereby reducing the coupling capacitance between the pixel electrodes 21 and other metal layers and the coupling capacitance between the common electrode 19 and other metal layers, and further reducing power consumption.

FIG. 11 is another schematic diagram of a position of a light shielding layer 9 according to an embodiment of the present disclosure. The array substrate 1 further includes touch signal lines 17 arranged on the side of the planarization layer 13 facing away from the base substrate 4, and a first insulating layer 18 provided on the side of each of the touch signal lines 17 facing away from the base substrate 4.

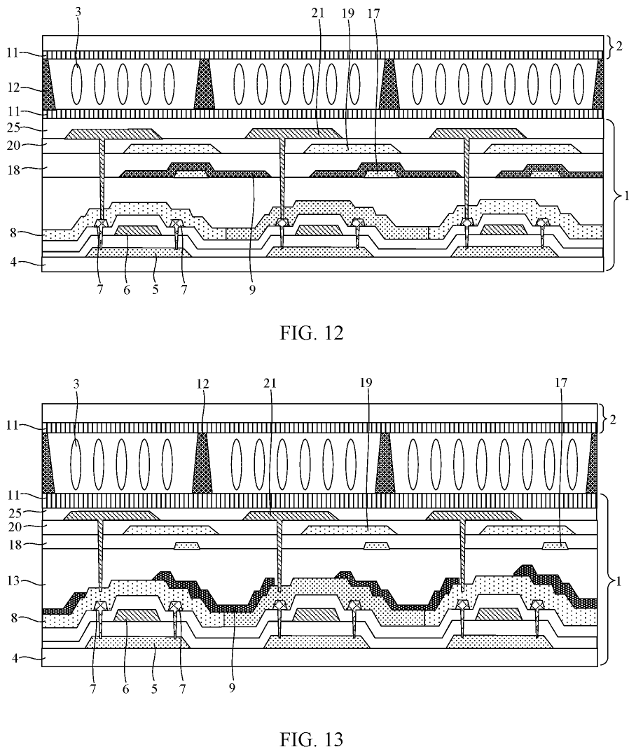

In view of the above, refer to FIG. 11 again, at least part of the light shielding layer 9 is located between the touch signal lines 17 and the planarization layer 13; or, as shown in FIG. 12, FIG. 12 is another schematic diagram of a position of a light shielding layer according to an embodiment of the present disclosure, and at least part of the light shielding layer 9 is located between the touch signal lines 17 and the first insulating layer 18.

With the above configuration, under the premise of effectively improving light leakage of the metal and keeping the low temperature poly-silicon display panel with a high aperture ratio, on the one hand, the light shielding layer 9 is relatively close to the planarization layer 13. In particular, when the light shielding layer 9 is located between the touch signal lines 17 and the planarization layer 13, the light shielding layer 9 is directly arranged on a surface of the planarization layer 13. With reference to FIG. 3, when the at least one groove 16 is provided on the planarization layer 13 to form a height difference, the grayscale difference of the light shielding layer 9 is greatly affected by the height difference, which makes the grayscale difference larger and easier to be recognized. On the other hand, a distance between the light shielding layer 9 and the touch signal lines 17 and a distance between the source-drain layer 7 and the gate layer 6 are relatively small. When the low temperature poly-silicon display panel is bent, the deformation degrees of the light shielding layer 9 and the part of the metal layer that are located in a same region under the bending force are similar to each other, thereby further ensuring that this part of the metal layer is covered by the light shielding layer 9, and greatly reducing the risk of this part of the metal layer being exposed to the opening region 10.

Optionally, referring to FIG. 4 to FIG. 12 again, the color filter layer 8 is located on the surface of the source-drain layer 7 facing away from the base substrate 4 to ensure that the color filter layer 8 will not be affected by the high-temperature manufacturing process to improve the reliability thereof. Moreover, when the color filter layer 8 is arranged on the surface of the source-drain layer 7 facing away from the base substrate 4, the color filter layer 8 directly contacts an interlayer dielectric layer located between the source-drain layer 7 and the gate layer 6. At present, the interlayer dielectric layer is commonly made of silicon oxide or silicon nitride material, and the adhesion between the color filter material forming the color filter layer and the silicon oxide or silicon nitride material is relatively high, which improves the reliability of the arrangement of the color filter layer 8 and is conducive to mass production.

FIG. 13 is another schematic diagram of a position of a light shielding layer according to an embodiment of the present disclosure. The array substrate 1 further includes the planarization layer 13 located on the side of the source-drain layers 7 facing away from the base substrate 4, and the color filter layer 8 and at least part of the light shielding layer 9 are located between the source-drain layer 7 and the planarization layer 13. Such configuration is capable of effectively improving the phenomenon of light leakage of the metal under the premise of ensuring that the low temperature poly-silicon display panel has a higher aperture ratio, and is also capable of ensuring that the color filter layer 8 and the light shielding layer 9 will not be affected by the high-temperature manufacturing process.

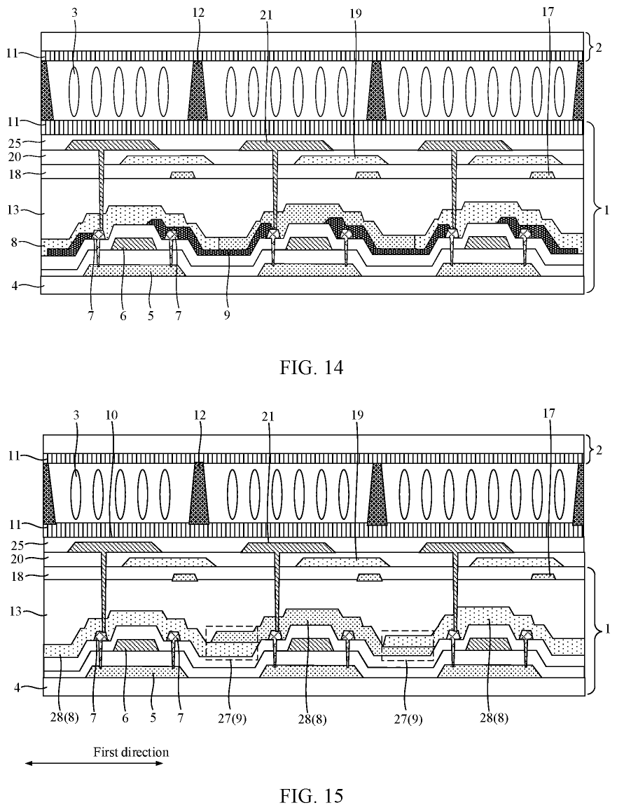

Further, refer to FIG. 13 again, in order to achieve a better light shielding effect, at least part of the light shielding layer 9 is located on the side of the color filter layer 8 facing away from the base substrate 4; or, as shown in FIG. 14, FIG. 14 is another schematic diagram of a position of a light shielding layer according to an embodiment of the present disclosure, and the color filter layer 8 is located on the side of at least part of the light shielding layer 9 facing away from the base substrate 4. With such configuration, a distance between the light shielding layer 9 and the source-drain layer 7 and a distance between the light shielding layer 9 and the gate layer 6 are relatively small. When the low temperature poly-silicon display panel is bent, the light shielding layer 9 and the part of the metal layer that are located in the same region have similar deformation degrees under the bending force, so as to further ensure that this part of the metal layer is covered by the light shielding layer 9 and to further reduce the risk of this part of the metal layer being exposed to the opening region 10.

FIG. 15, in conjunction with FIG. 1, is another schematic diagram of a position of a light shielding layer according to an embodiment of the present disclosure. The light shielding layer 9 includes a first light shielding portion 26 extending along a first direction and a second light shielding portion 27 extending along a second direction. The first light shielding portion 26 and the second light shielding portion 27 intersect to define the opening region 10 of the low temperature poly-silicon display panel. The color filter layer 8 includes color filters 28 of a plurality of colors. In the first direction, two adjacent color filters 28 of different colors overlap each other, and an overlapping part of the two adjacent color filters 28 is reused as the second light shielding portion 27. It should be noted that the first direction refers to a direction parallel to the bending direction of the low temperature poly-silicon display panel. Accordingly, the first light shielding portion 26 refers to a portion of the light shielding layer 9 extending along the bending direction of the low temperature poly-silicon display panel.

For a color filter 28 of a certain color, the color filter 28 only allows light within a wavelength range corresponding to the light of this color to be emitted. For example, a red color filter only emits red light within a wavelength range from 625 nm to 740 nm. When the color filter 28 of one color is superimposed on the color filter 28 of another color, since the light of the two colors corresponds to different wavelength ranges, the light emitted through the color filter 28 of the one color cannot be further emitted from the color filter 28 of the another color, thereby achieving a light shielding effect. The overlapped portions of the color filters 28 of different colors are reused as the second light shielding portion 27 such that additional process is not required to form the second light shielding potion 27, which simplifies the manufacturing process, reduces the manufacturing cost, and also reduces the thickness of the low temperature poly-silicon display.

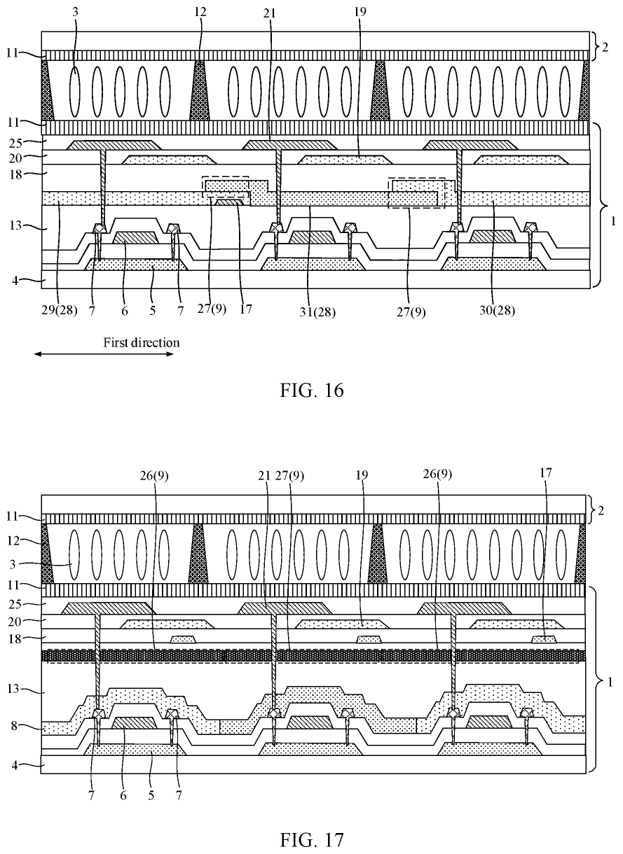

FIG. 16 is another schematic diagram of a position of a light shielding layer according to an embodiment of the present disclosure. The color filters 28 include a red color filter 29, a green color filter 30, and a blue color filter 31. The array substrate 1 also includes a touch signal line 17 located on a side of the color filter layer 8 facing toward the base substrate 4. In a direction perpendicular to a plane of the base substrate 4, the touch signal line 17 is overlapped with a part where the red color filter 29 and the blue color filter 31 overlap. The wavelength range of red light is from 625 nm to 740 nm, and the wavelength range of blue light is from 440 nm to 485 nm. The corresponding wavelength ranges of the light of the two colors are significantly different. Therefore, the second light shielding portion 27 formed by overlapping the red color filter 29 and the blue color filter 31 has a better light shielding effect. The touch signal line 17 overlaps with the overlapping portion of the red color filter 29 and the blue color filter 31 so that the shielding effect of the touch signal line 17 is capable of being improved and the metal of the touch signal line 17 may be avoided to be visible.

FIG. 17 is a cross-sectional view of FIG. 1 along B1-B2, and the light shielding layer 9 includes a first light shielding portion 26 extending in a first direction and a second light shielding portion 27 extending in a second direction. The first light shielding portion 26 and the second light shielding portion 27 intersect to define the opening region 10 of the low temperature poly-silicon display panel. The first light shielding portion 26 and the second light shielding portion 27 are both located on the array substrate 1. It should be noted that the first direction refers to a direction parallel to the bending direction of the low temperature poly-silicon display panel. Therefore, the first light shielding portion 26 refers to a portion of the light shielding layer 9 extending along the bending direction of the low temperature poly-silicon display panel.

The first light shielding portion 26 and the second light shielding portion 27 are both arranged on the array substrate 1, that is, the entire light shielding layer 9 in the opening region 10 is defined to be arranged on the same side as the metal layers. When the low temperature poly-silicon display panel is bent, the relative positional relationship between the metal layers and the entire light shielding layer 9 will not be affected by the alignment factor between the array substrate 1 and the alignment substrate 2, thereby further improving the phenomenon of light leakage of the metal.

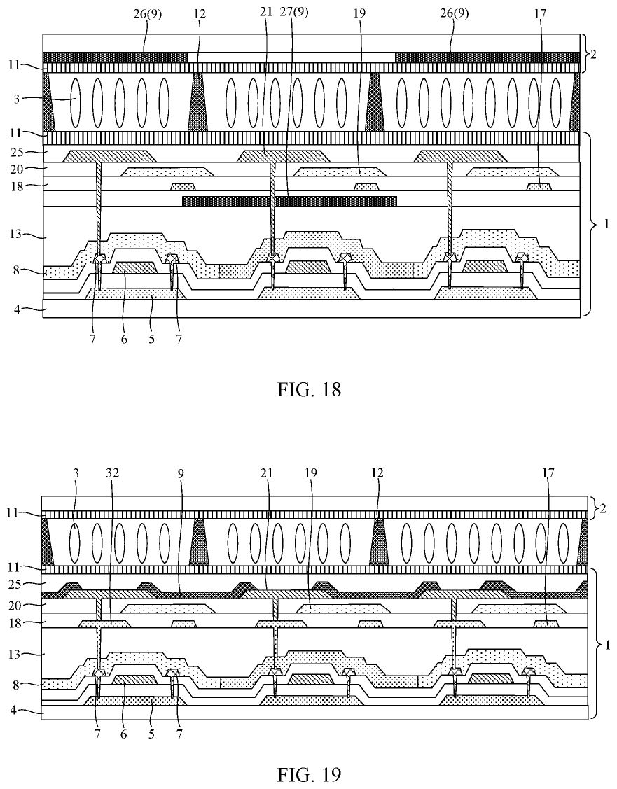

FIG. 18 is another cross-sectional view of FIG. 1 along the B1-B2. The light shielding layer 9 includes a first light shielding portion 26 extending in a first direction and a second shielding portion 27 extending in a second direction. The first light shielding portion 26 and the second light shielding portion 27 intersect to define the opening region 10 of the low temperature poly-silicon display panel. The second light shielding portion 27 is located on the array substrate 1, and the first light shielding portion 26 is located on the alignment substrate 2. It should be noted that the first direction refers to the direction parallel to the bending direction of the low temperature poly-silicon display panel. Therefore, the first light shielding portion 26 refers to a portion of the light shielding layer 9 extending along the bending direction of the low temperature poly-silicon display panel.

Since the opening region 10 is defined by the first light shielding portion 26 and the second light shielding portion 27, the second light shielding portion 27 is arranged on the array substrate 1. When the low temperature poly-silicon display panel is bent, the metal layers may still be shielded by the second light shielding portion 27, which is also capable of reducing the risk of the metal layers being exposed in the opening region 10.

In addition, in some embodiments of the present disclosure, after the color filter layer 8 and/or the light shielding layer 9 are integrated and disposed on the array substrate 1, the distance between the source-drain layer 7 and each of the pixel electrodes 21 is increased. When the pixel electrodes 21 are electrically connected to the source-drain layer 7 through the via, the depth of the via is larger and the process is more difficult. Therefore, as shown in FIG. 19, FIG. 19 is a schematic diagram of a position of a connection layer according to an embodiment of the present disclosure. A connection layer 32 may be provided on the array substrate 1, the connection layer 32 and the touch signal lines 17 are arranged in the same layer, and the pixel electrodes 21 are electrically connected to the source-drain layer 7 through the connection layer 32. With such configuration, the via between the pixel electrodes 21 and the connection layer 32, and the via between the connection layer 32 and the source-drain layer 7 have small depths, which not only reduces the processing difficulty, but also improves the connecting stability between the pixel electrodes 21 and the source-drain layer 7. Moreover, the connection layer 32 and the touch signal lines 17 are arranged in the same layer, which prevents the connection layer 32 from occupying additional layer space, and the connection layer 32 and the touch signal lines 17 may be formed by the same patterning process, which simplifies the process of the connection layer 32.

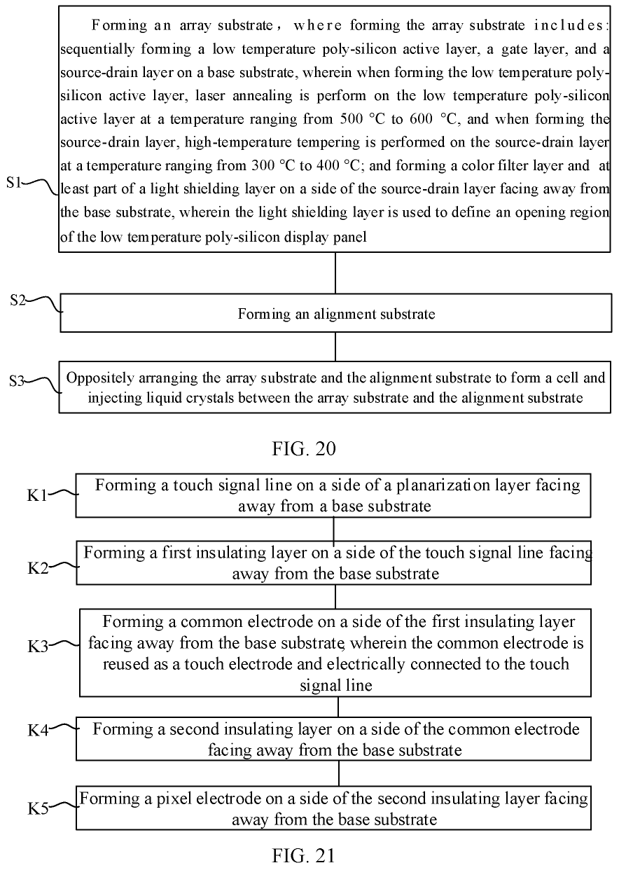

Some embodiments of the present disclosure also provide a manufacturing method of the low temperature poly-silicon display panel. The manufacturing method is used to manufacture the above-mentioned low temperature poly-silicon display panel. With reference to FIG. 1 and FIG. 2, as shown in FIG. 20, FIG. 20 is a flowchart of the manufacturing method according to an embodiment of the present disclosure, and the manufacturing method includes following steps.

In a step S1, the array substrate 1 is formed. The process of forming the array substrate 1 includes forming the low temperature poly-silicon active layer 5, the gate layer 6 and the source-drain layer 7 in sequence on the base substrate 4. When forming the low temperature poly-silicon active layer 5, laser annealing is performed on the low temperature poly-silicon active layer 5 at a temperature ranging from 500° C. to 600° C., and when forming the source-drain layer 7, high-temperature tempering is performed on the source-drain layer 7 at a temperature ranging from 300° C. to 400° C. The color filter layer 8 and at least part of the light shielding layer 9 are formed on the side of the source-drain layer 7 facing away from the base substrate 4, and the light shielding layer 9 is used to define the opening region 10 of the low temperature poly-silicon display panel.

It should be noted that when the gate layer 6 is formed, tempering may be selectively performed on the gate layer 6 in accordance with the material for forming the gate layer 6. For example, if the metal material for forming the gate layer 6 has a poor electrical conductivity, high-temperature tempering is performed on the gate layer 6 at a temperature ranging from 300° C. to 400° C. to enhance the electrical conductivity of the gate layer 6; and if the metal material for forming the gate layer 6 has a strong electrical conductivity, there is unnecessary to perform the high-temperature tempering.

In a step S2, the alignment substrate 2 is formed.

In a step S3, the array substrate 1 and the alignment substrate 2 are oppositely arranged, and the liquid crystals 3 are injected between the array substrate 1 and the alignment substrate 2.

In the technical solutions according to the embodiments of the present disclosure, the metal layers on the array substrate 1, such as the gate layer 6 and the source-drain layer 7, are located at a same side as the light shielding layer 9. When the low temperature poly-silicon display panel is bent, the relative positional relationship between the metal layers and this part of the light shielding layer 9 will not be affected by the alignment factors between the array substrate 1 and the alignment substrate 2. The metal layers and the light shielding layer 9 that are located in the same region of the array substrate 1 have similar deformation degrees under the same bending force, such that the metal layers in this region are still shielded by the light shielding layer 9, reducing the risk of the metal layers being exposed in the opening region 10, thereby effectively improving the phenomenon of light leakage of the metal. Moreover, with the technical solutions according to the embodiments of the present disclosure, the coverage area of the light shielding layer 9 is not required to be adjusted, so that the low temperature poly-silicon display panel still maintains a relatively high aperture ratio and has a better display performance.

Moreover, in some embodiments of the present disclosure, the color filter layer 8 and at least part of the light shielding layer 9 are arranged on the side of the source-drain layer 7 facing away from the base substrate 4, such that the process flow of the high-temperature processing required for the low temperature poly-silicon display panel is performed before forming the color filter layer 8 and the light shielding layer 9. After the color filter layer 8 and the light shielding layer 9 are formed, it is unnecessary to perform high-temperature treatment, thereby preventing the color filter layer 8 and the light shielding layer 9 from being affected by high temperature factors. Therefore, the reliability of the arrangement of the color filter layer 8 and the light shielding layer 9 is improved, and the feasibility of integrating the color filter layer 8 and the light shielding layer 9 on the array substrate 1 is improved.

Optionally, in conjunction with FIG. 2, in order to achieve planarization, the process of forming the array substrate 1 further includes forming the planarization layer 13 on the surface of the color filter layer 8 facing away from the base substrate 4, and the process of forming the at least part of the light shielding layer 9 on the side of the source-drain layer 7 facing away from the base substrate 4 includes forming the at least part of the light shielding layer 9 on the side of the planarization layer 13 facing away from the base substrate 4.

Optionally, in conjunction with FIG. 1 and FIG. 3, the array substrate 1 has the display region 14 and the non-display region 15 surrounding the display region 14. The process of forming the planarization layer 13 includes extending the planarization layer 13 from the display region 14 to the non-display region 15, and providing the at least one groove 16 on the planarization layer 13, such that the at least one groove 16 is located in the non-display region 15. With such configuration, a height difference is formed between the position of the at least one groove 16 and the surrounding position. When subsequently coating with the light shielding material to form the light shielding layer, the light shielding layer will be recessed at the at least one groove 16 such that the light shielding layer forms a grayscale difference between the position of the at least one groove 16 and the surrounding position. When the mask is aligned, the formed grayscale difference may be used as an alignment mark to achieve precise alignment, improve the etching accuracy, and improve the accuracy of the arranging position of the opening region 10.

Moreover, compared with other layers on the array substrate 1, the planarization layer 13 has a relatively large thickness. Therefore, the at least one groove 16 is provided on the planarization layer 13 such that the height difference between the position of the at least one groove 16 and the surrounding position is larger. After coating with the light shielding material subsequently to form the light shielding layer, the grayscale difference between the position of the at least one groove 16 and the surrounding position is more significant and thus is easier to be recognized.

FIG. 21 is another flowchart of a manufacturing method according to an embodiment of the present disclosure. A process of forming the array substrate 1 further includes:

step K1: forming the touch signal lines 17 on the side of the planarization layer 13 facing away from the base substrate 4;

step K2: forming the first insulating layer 18 on the side of the touch signal lines 17 facing away from the base substrate 4;

step K3: forming the common electrode 19 on the side of the first insulating layer 18 facing away from the base substrate 4, wherein the common electrode 19 is reused as touch electrodes and electrically connected to the touch signal lines 17;

step K4: forming the second insulating layer 20 on the side of the common electrode 19 facing away from the base substrate 4; and

step K5, forming pixel electrodes 21 on the side of the second insulating layer 20 facing away from the base substrate 4.

In view of the above, the process of forming at least part of the light shielding layer 9 on the side of the planarization layer 13 facing away from the base substrate 4 includes forming the at least part of the light shielding layer 9 on the side of each of the pixel electrodes 21 facing away from the base substrate 4. In this way, under the premise of effectively improving light leakage of the metal and keeping the low temperature poly-silicon display panel with a high aperture ratio, when forming the light shielding layer 9, the process of forming the light shielding layer 9 is required only after forming the pixel electrodes 21, and the original process of the array substrate 1 will not be greatly affected.

Further, in conjunction with FIG. 7, the third via 24 is provided on the first insulating layer 18, the second via 23 is provided on the common electrode 19, the first via 22 is provided on the second insulating layer 20, and a part of the light shielding layer 9 is deposited in the first via 22, the second via 23, and the third via 24. Alternatively, in conjunction with FIG. 6, the common electrode 19 is provided with the second via 23, the second insulating layer 20 is provided with the first via 22, and a part of the light shielding layer 9 is deposited in the first via 22 and the second via 23. Alternatively, in conjunction with FIG. 5, the second insulating layer 20 is provided with the first via 22, and a part of the light shielding layer 9 is deposited in the first via 22. The first via 22, the second via 23 and the third via 24 are located in the non- opening region of the low temperature poly-silicon display panel.

The vias are formed on the layers located on the side of the light shielding layer 9 facing toward the base substrate 4 such that when coating with the light shielding material to form the light shielding layer 9, a part of the light shielding material sinks into the vias. In this way, the layer thickness of the light shielding layer 9 formed by the light shielding material is reduced to avoid large undulation of the upper surface of the array substrate due to the excessive large thickness of the light shielding layer 9, which is beneficial to the subsequent coating and alignment of the alignment layer 11. In addition, it is also beneficial for the small molecular substances that are not completely volatilized in the organic layer such as the color filter layer 8 to be further volatilized through the vias in the subsequent manufacturing process, so as to prevent the small molecular substances from remaining in the panel and affecting the working stability of the panel.

Further, with reference to FIG. 4, the process of forming the array substrate 1 further includes forming the liquid adhesive 25 on the side of the light shielding layer 9 facing away from the base substrate 4. On the one hand, the liquid adhesive 25 is applied to planarize an upper surface of the overall layer of the array substrate 1, which is beneficial to the subsequent coating and alignment of the alignment layer 11. On the other hand, with reference to FIG. 5 to FIG. 7, when vias, such as the first via 22, the second via 23 and the third via 24, are formed on the layers under the light shielding layer 9, the layer thickness of the light shielding layer 9 is relatively small, and the undulation degree of the upper surface of the overall layer of the array substrate 1 is also relatively small. When coating with the liquid adhesive 25, only a thinner liquid adhesive 25 is used to achieve the planarization, thereby reducing the distance between the pixel electrodes 21 and the liquid crystals 3, and improving the driving effect of the pixel electrodes 21 on the liquid crystals 3. In addition, the liquid adhesive 25 may also isolate the light shielding layer 9 to prevent the liquid crystals 3 from being contaminated by additives in the organic material for forming the light shielding layer 9.

Optionally, referring to FIG. 21 again, the process of forming the array substrate 1 further includes:

step Kl: forming the touch signal lines 17 on the side of the planarization layer 13 facing away from the base substrate 4;

step K2: forming the first insulating layer 18 on the side of each of the touch signal lines 17 facing away from the base substrate 4;

step K3: forming the common electrode 19 on the side of the first insulating layer 18 facing away from the base substrate 4, wherein the common electrode 19 is reused as touch electrodes and electrically connected to the touch signal lines 17;

step K4: forming the second insulating layer 20 on the side of the common electrode 19 facing away from the base substrate 4; and

step K5: forming the pixel electrodes 21 on the side of the second insulating layer 20 facing away from the base substrate 4.

In view of the above, the process of forming the at least part of the light shielding layer 9 on the side of the planarization layer 13 facing away from the base substrate 4 includes: in conjunction with FIG. 8, forming the at least part of the light shielding layer 9 between the second insulating layer 20 and the pixel electrodes 21; or, in conjunction with FIG. 10, forming the at least part of the light shielding layer 9 between the common electrode 19 and the first insulating layer 18; or, in conjunction with FIG. 9, forming the at least part of the light shielding layer 9 between the common electrode 19 and the second insulating layer 20. With the above configuration, under the premise of effectively improving the light leakage of the metal and keeping the low temperature poly-silicon display panel with a high aperture ratio, on the one hand, the light shielding layer 9 is located on the side of each of the touch signal lines 17 facing away from the base substrate 4, and besides shielding the metal layers, such as, the source-drain layer 7 and the gate layer 6, the light shielding layer 9 also shields the touch signal lines 17, thereby greatly reducing the risk of the metal being visible. On the other hand, with the light shielding layer 9, the distance between the pixel electrodes 21 and other metal layers (such as the touch signal lines 17, the source-drain layer 7, and the gate layer 6) and the distance between the common electrode 19 and these other metal layers are increased, thereby reducing the coupling capacitance between the pixel electrodes 21 and these other metal layers and the coupling capacitance between the common electrode 19 and these other metal layers and thus further reducing the power consumption.

Alternatively, the process of forming the at least part of the light shielding layer 9 on the side of the planarization layer 13 facing away from the base substrate 4 includes: in conjunction with FIG. 11, forming the at least part of the light shielding layer 9 between the touch signal lines 17 and the planarization layer 13; or, in conjunction with FIG. 12, forming the at least part of the light shielding layer 9 between the touch signal lines 17 and the first insulating layer 18. With the above configuration, under the premise of effectively improving the light leakage of the metal and keeping the low temperature poly-silicon display panel with a high aperture ratio, on the one hand, the light shielding layer 9 is closer to the planarization layer 13. In particular, when the light shielding layer 9 is located between the touch signal lines 17 and the planarization layer 13, the light shielding layer 9 is directly arranged on the surface of the planarization layer 13. With reference to FIG. 3, when the at least one groove 16 is provided on the planarization layer 13 to form a height difference, the grayscale difference of the light shielding layer 9 is greatly affected by the height difference, which makes the grayscale difference larger and easier to be recognized. On the other hand, the distance between the light shielding layer 9 and the touch electrodes 17, the distance between the light shielding layer 9 and the source drain layer 7, and the distance between the light shielding layer 9 and the gate layer 6 are relatively small. When the low temperature poly-silicon display panel is bent, the light shielding layer 9 and the part of the metal layer that are located in the same region have similar deformation degrees under the bending force, thereby further ensuring that the part of the metal layer is covered by the light shielding layer 9 and greatly reducing the risk of this part of the metal layer being exposed to the opening region 10.

Optionally, in conjunction with FIG. 13 and FIG. 14, the process of forming the color filter layer 8 and the at least part of the light shielding layer 9 on the side of the source-drain layer 7 facing away from the base substrate 4 includes forming the color filter layer 8 on the side of the source-drain layer 7 facing away from the base substrate 4, forming the at least part of the light shielding layer 9 on the side of the color filter layer 8 facing away from the base substrate 4, and forming the planarization layer 13 on the side of the at least part of the light shielding layer 9 facing away from the base substrate 4; or forming the at least part of the light shielding layer 9 on the side of the source-drain layer 7 facing away from the base substrate 4, forming the color filter layer 8 on the side of the at least part of the light shielding layer 9 facing away from the base substrate, and forming the planarization layer 13 on the side of the color filter layer 8 facing away from the base substrate 4. With the above configuration, the distance between the light shielding layer 9 and the source-drain layer 7 and the distance between the light shielding layer 9 and the gate layer 6 are relatively small. When the low temperature poly-silicon display panel is bent, the light shielding layer 9 and the metal layers that are located in the same region have similar deformation degrees under the bending force, so as to further ensure that this part of the metal layers is covered by the light shielding layer 9 and to greatly reduce the risk of this part of the metal layer being exposed to the opening region 10.

Optionally, with reference to FIG. 1 and FIG. 15, the process of forming the color filter layer 8 on the side of the source-drain layer 7 facing away from the base substrate 4 includes forming color filters 28 of multiple colors on the side of the source-drain layer 7 facing away from the base substrate 4. In the first direction, two adjacent color filters 28 of different colors overlap. The light shielding layer 9 includes the first light shielding portion 26 and the second light shielding portion 27, the first light shielding portion 26 extends along the first direction, and the second light shielding portion 27 extends along the second direction. The first light shielding portion 26 and the second light shielding portion 27 intersect to define the opening region 10 of the low temperature poly-silicon display panel, and an overlapping part of two adjacent color filters 28 is reused as the second light shielding portion 27. The overlapping part of the color filters 28 of different colors is reused as the second light shielding portion 27, so that additional process is not required to form the second light shielding portion 27, which simplifies the manufacturing process, reduces the manufacturing cost, and also reduces cell gap of the low temperature poly-silicon display.

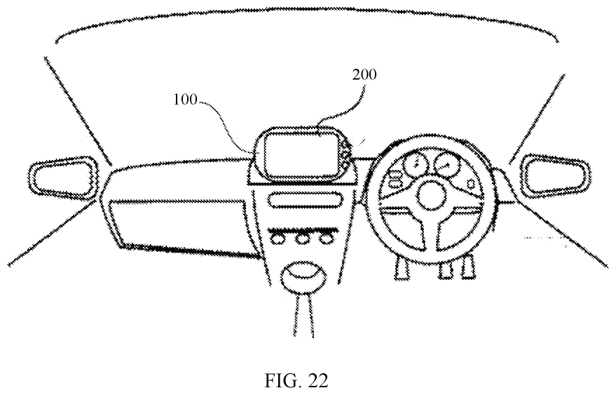

Some embodiments of the present disclosure further provide a liquid crystal display device including the above-mentioned low temperature poly-silicon display panel. Specifically, the liquid crystal display device may be an electronic display device such as a vehicular display screen, a mobile phone, a computer, or a TV. When the liquid crystal display device is used as the vehicular display screen, it is applicable in vehicles, such as cars, ships, or airplanes. For example, the liquid crystal display device is applied to a car, as shown in FIG. 22. FIG. 22 is a schematic structural diagram of a liquid crystal display device according to an embodiment of the present disclosure. The liquid crystal display device 100 includes the above-mentioned low temperature poly-silicon display panel 200. The liquid crystal display device 100 may be an inherent structure located in and independent from the car, or can be integrated with other structures in the car, such as integrated with the front windshield or integrated with the countertop around the dashboard, which is not limited in the embodiment of the present disclosure.

Since the liquid crystal display device 100 according to the embodiments of the present disclosure includes the aforementioned low temperature poly-silicon display panel 200, the liquid crystal display device 100 functions to effectively improve the light leakage of the metal while maintaining a high aperture ratio, the color filter layer 8 and the light shielding layer 9 can also be prevented from being affected by the high-temperature process. Accordingly, the reliability of the arrangement of the color filter layer 8 and the light shielding layer 9 and further improves the feasibility of integrating the color filter layer 8 and the light shielding layer 9 on the array substrate 1.

The above description only illustrates preferred embodiments of the present disclosure and is not intended to limit the present disclosure thereto. Any modification, equivalent replacement, improvement, and so on can be made by those skilled in the art within the spirit and principle of the present disclosure and should fall within the scope of the present disclosure.

Finally, it should be noted that the above embodiments are only used to illustrate the technical solutions of the present disclosure, but not to limit thereto. Although the present disclosure has been described in detail with reference to the foregoing embodiments, those skilled in the art should understand that the technical solutions described in the foregoing embodiments may be modified or some or all of the technical features may be equivalently replaced. The essence of technical solutions corresponding to these modifications or replacements do not deviate from the scope of the technical solutions of the embodiments of the present disclosure.

1. A low temperature poly-silicon display panel, comprising:
an array substrate and an alignment substrate opposite the array substrate, wherein the array substrate comprises a base substrate, and a low temperature poly-silicon active layer, a gate layer, and a source-drain layer are sequentially arranged on the base substrate along a light emitting direction;
liquid crystals filled between the array substrate and the alignment substrate;
a color filter layer provided on the array substrate and located on a side of the source-drain layer facing away from the base substrate; and
a light shielding layer configured to define an opening region of the low temperature poly-silicon display panel, wherein at least part of the light shielding layer is provided on the array substrate, and the light shielding layer provided on the array substrate is located on the side of the source-drain layer facing away from the base substrate
wherein the array substrate further comprises a planarization layer located on a side of the color filter layer facing away from the base substrate; and
wherein the at least part of the light shielding layer is located on a side of the planarization layer facing away from the base substrate.

2. (canceled)

3. The low temperature poly-silicon display panel according to claim 1, wherein the array substrate has a display region and a non-display region surrounding the display region, and the planarization layer extends from the display region to the non-display region and is provided with at least one groove located in the non-display region.

4. The low temperature poly-silicon display panel according to claim 1, wherein the planarization layer is hollow within the at least one groove.

5. The low temperature poly-silicon display panel according to claim 1, wherein the array substrate further comprises:
touch signal lines provided on the side of the planarization layer facing away from the base substrate;
a first insulating layer provided on a side of each of the touch signal lines facing away from the base substrate;
a common electrode provided on a side of the first insulating layer facing away from the base substrate, wherein the common electrode is reused as touch electrodes and is electrically connected to the touch signal lines;
a second insulating layer provided on a side of the common electrode facing away from the base substrate; and
pixel electrodes provided on a side of the second insulating layer facing away from the base substrate,
wherein the at least part of the light shielding layer is located on a side of each of the pixel electrodes facing away from the base substrate.

6. The low temperature poly-silicon display panel according to claim 5, wherein the second insulating layer is provided with a first via, and a part of the light shielding layer is deposited in the first via of the second insulating layer; or
the second insulating layer is provided with a first via, the common electrode is provided with a second via, and a part of the light shielding layer is deposited in the first via and the second via; or
the second insulating layer is provided with a first via, the common electrode is provided with a second via, the first insulating layer is provided with a third via, and a part of the light shielding layer is deposited in the first via, the second via and the third via; and
wherein the first via, the second via and the third via are located in a non-opening region of the low temperature poly-silicon display panel.

7. The low temperature poly-silicon display panel according to claim 6, wherein a liquid adhesive is formed on a side of the light shielding layer facing away from the base substrate.

8. The low temperature poly-silicon display panel according to claim 1, wherein the array substrate further comprises:
touch signal lines provided on the side of the planarization layer facing away from the base substrate;
a first insulating layer provided on a side of each of the touch signal lines facing away from the base substrate;
a common electrode provided on a side of the first insulating layer facing away from the base substrate, wherein the common electrode is reused as touch electrodes and is electrically connected to the touch signal lines;
a second insulating layer provided on a side of the common electrode facing away from the base substrate; and
pixel electrodes provided on a side of the second insulating layer facing away from the base substrate,
wherein the at least part of the light shielding layer is located between the second insulating layer and the pixel electrodes, or located between the common electrode and the first insulating layer, or located between the common electrode and the second insulating layer.

9. The low temperature poly-silicon display panel according to claim 1, wherein the array substrate further comprises:
touch signal lines provided on the side of the planarization layer facing away from the base substrate; and
a first insulating layer provided on a side of each of the touch signal lines facing away from the base substrate,
wherein the at least part of the light shielding layer is located between the touch signal lines and the planarization layer, or located between the touch signal lines and the first insulating layer.

10. The low temperature poly-silicon display panel according to claim 1, wherein the array substrate further comprises a planarization layer, and the planarization layer is located on the side of the source-drain layer facing away from the base substrate; and
the color filter layer and the at least part of the light shielding layer are located between the source-drain layer and the planarization layer.

11. The low temperature poly-silicon display panel according to claim 10, wherein the at least part of the light shielding layer is located on a side of the color filter layer facing away from the base substrate; or the color filter layer is located on a side of the at least part of the light shielding layer facing away from the base substrate.

12. The low temperature poly-silicon display panel according to claim 1, wherein the light shielding layer comprises a first light shielding portion extending along a first direction and a second light shielding portion extending along a second direction, and the first light shielding portion and the second light shielding portion intersect to define the opening region of the low temperature poly-silicon display panel; and
the color filter layer comprises color filters of a plurality of colors, in the first direction, two adjacent color filters of different colors in the color filters overlap, and an overlapping part of the two adjacent color filters is reused as the second light shielding portion.

13. The low temperature poly-silicon display panel according to claim 12, wherein the color filters comprise a red color filter, a green color filter, and a blue color filter; and
the array substrate further comprises at least one touch signal line located on a side of the color filter layer facing toward the base substrate, and in a direction perpendicular to a plane of the base substrate, the touch signal line overlaps with an overlapping part of the red color filter and the blue color filter.

14. (canceled)

15. The low temperature poly-silicon display panel according to claim 1, wherein the light shielding layer comprises a first light shielding portion extending along a first direction and a second light shielding portion extending along a second direction, and the first light shielding portion and the second light shielding portion intersect to define the opening region of the low temperature poly-silicon display panel; and
the second light shielding portion is located on the array substrate, and the first light shielding part is located on the alignment substrate.

16. A manufacturing method of the low temperature poly-silicon display panel according to claim 1, comprising:
forming the array substrate;
forming the alignment substrate; and
oppositely arranging the array substrate and the alignment substrate to form a cell and injecting the liquid crystals between the array substrate and the alignment substrate,
wherein said forming the array substrate comprises:
sequentially forming the low temperature poly-silicon active layer, the gate layer, and the source-drain layer on the base substrate, wherein when forming the low temperature poly-silicon active layer, laser annealing is performed on the low temperature poly-silicon active layer at a temperature ranging from 500° C. to 600° C., and when forming the source-drain layer, high- temperature tempering is performed on the source-drain layer at a temperature ranging from 300° C. to 400° C.;
forming the color filter layer and the at least part of the light shielding layer on the side of the source-drain layer facing away from the base substrate;
forming a planarization layer on a surface of the color filter layer facing away from the base substrate; and
forming the at least part of the light shielding layer on a side of the planarization layer facing away from the base substrate, wherein the light shielding layer is configured to define the opening region of the low temperature poly-silicon display panel.

17. (canceled)

18. The manufacturing method according to claim 16, wherein the array substrate has a display region and a non-display region surrounding the display region; and
said forming the planarization layer comprises extending the planarization layer from the display region to the non-display region, and forming at least one groove on the planarization layer in such a manner that the at least one groove is located in the non-display region.

19. The manufacturing method according to claim 16, wherein said forming the array substrate further comprises:
forming touch signal lines on the side of the planarization layer facing away from the base substrate;
forming a first insulating layer on a side of each of the touch signal lines facing away from the base substrate;
forming a common electrode on a side of the first insulating layer facing away from the base substrate, wherein the common electrode is reused as touch electrodes and is electrically connected to the touch signal lines;
forming a second insulating layer on a side of the common electrode facing away from the base substrate; and
forming pixel electrodes on a side of the second insulating layer facing away from the base substrate; and
wherein said forming the at least part of the light shielding layer on the side of the planarization layer facing away from the base substrate comprises forming the at least part of the light shielding layer on a side of each of the pixel electrodes facing away from the base substrate.

20. The manufacturing method according to claim 19, wherein the first insulating layer is provided with a third via, the common electrode is provided with a second via, the second insulating layer is provided with a first via, and a part of the light shielding layer is deposited in the first via, the second via and the third via; or
the common electrode is provided with a second via, the second insulating layer is provided with a first via, and a part of the light shielding layer is deposited in the first via and the second via; or
the second insulating layer is provided with a first via, and a part of the light shielding layer is deposited in the first via; and
wherein the first via, the second via and the third via are located in a non-opening region of the low temperature poly-silicon display panel.

21. (canceled)

22. The manufacturing method according to claim 16, wherein said forming the array substrate further comprises:
forming touch signal lines on the side of the planarization layer facing away from the base substrate;
forming a first insulating layer on a side of each of the touch signal lines facing away from the base substrate;
forming a common electrode on a side of the first insulating layer facing away from the base substrate, wherein the common electrode is reused as touch electrodes and is electrically connected to the touch signal lines;
forming a second insulating layer on a side of the common electrode facing away from the base substrate; and
forming pixel electrodes on a side of the second insulating layer facing away from the base substrate; and
wherein said forming the at least part of the light shielding layer on the side of the planarization layer facing away from the base substrate comprises: forming the at least part of the light shielding layer between the second insulating layer and the pixel electrodes, or between the common electrode and the first insulating layer, or between the common electrode and the second insulating layer, or between the touch signal lines and the planarization layer, or between the touch signal lines and the first insulating layer.

23. The manufacturing method according to claim 16, wherein said forming the color filter layer and the at least part of the light shielding layer on the side of the source-drain layer facing away from the base substrate comprises:
forming the color filter layer on the side of the source-drain layer facing away from the base substrate, forming the at least part of the light shielding layer on the side of the color filter layer away from the base substrate, and forming the planarization layer on a side of the at least part of the light shielding layer facing away from the base substrate; or
forming the at least part of the light shielding layer on the side of the source-drain layer facing away from the base substrate, forming the color filter layer on the side of the at least part of the light shielding layer color filter layer facing away from the base substrate, and forming the planarization layer on the side of the color filter layer facing away from the base substrate.

24. (canceled)

25. A liquid crystal display device, comprising a low temperature poly-silicon display panel, wherein the low temperature poly-silicon display panel comprises:
an array substrate and an alignment substrate opposite to the array substrate, wherein the array substrate comprises a base substrate, and a low temperature poly-silicon active layer, a gate layer, and a source-drain layer are sequentially arranged on the base substrate along a light emitting direction;
liquid crystals filled between the array substrate and the alignment substrate;
a color filter layer provided on the array substrate and located on a side of the source-drain layer facing away from the base substrate; and
a light shielding layer configured to define an opening region of the low temperature poly-silicon display panel, wherein at least part of the light shielding layer is provided on the array substrate, and the light shielding layer provided on the array substrate is located on the side of the source-drain layer facing away from the base substrate,
wherein the array substrate further comprises a planarization layer located on a side of the color filter layer facing away from the base substrate; and
wherein the at least part of the light shielding layer is located on a side of the planarization layer facing away from the base substrate.
